(19) United States
(12) Patent Application Publication
(10) Pub. No.: US 2008/0279190 A1
(43) Pub. Date: Nov. 13, 2008

(54) Maintaining End-to-End Packet Ordering

(76) Inventor: Raveendra Muniyappa, Bangalore (IN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/747,143

(22) Filed: May 10, 2007

(51) Int. Cl. H04L 12/56

(52) U.S. Cl. 370/394; 370/235; 370/412

(57) ABSTRACT

A network processor to maintain end-to-end packet ordering by re-ordering the packets processed in an order that is not the same as the order in which the packets are received. A first microblock stores a null value for a status flag corresponding to each packet, a second microblock modifies the null value to a first value or a second value respectively based on whether the packet is processed successfully, and a third microblock retrieves the values stored in the status flags of each packet and re-orders the packets.

### BACKGROUND

A computer network generally refers to a group of interconnected wired and/or wireless devices such as, for example, laptops, mobile phones, servers, fax machines, printers, etc. Computer networks often transfer data in the form of packets from one device to another device(s). An intermediate network device may consume processing cycles and such other computational resources while transferring packets.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a network environment.

FIG. 2 illustrates an embodiment of a network device of FIG. 1

FIG. 3 illustrates an embodiment of a processor of the network device of FIG. 2.

FIG. 4 illustrates an embodiment of various microblocks, supported on the processor, processing one or more packets.

FIG. 5 illustrates an embodiment of an operation of the receive microblock.

FIG. 6 illustrates an embodiment of an operation of the packet processing microblock.

FIG. 7 illustrates an embodiment of an operation of the Queue Manager (QM) microblock.

### DETAILED DESCRIPTION

The following description describes a system to maintain end-to-end packet ordering in a network processor. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

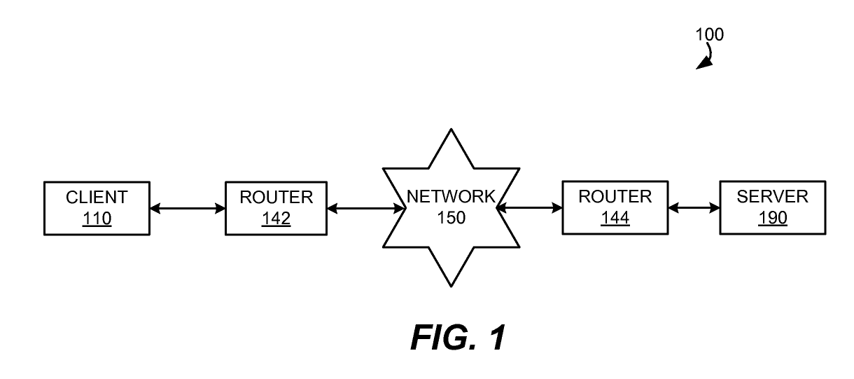

An embodiment of a network environment 100 is illustrated in FIG. 1. The network environment 100 may comprise a client 110, routers 142 and 144, a network 150, and a server 190. For illustration, the network environment 100 is shown comprising a small number of each type of device; however, a typical network environment may comprise a large number of each type of such devices.

The client 110 may comprise a desktop computer system, a laptop computer system, a personal digital assistant, a mobile phone, or any such computing system. The client 110 may generate one or more packets and send the packets to the network 150. The client 110 may receive the packets from the network 150 and process the packets before sending the packets to a corresponding application. The client 110 may be coupled to an intermediate network device such as the router 142 via a local area network (LAN) to send and receive the packets. The client 110 may, for example, support protocols such as a hyper text transfer protocol (HTTP), a file transfer protocol (FTP), and a TCP/IP suite of protocols.

The server 190 may comprise a computer system capable of sending the packets to the network 150 and receiving the packets from the network 150. The server 190 may generate a response packet after receiving a request packet from the client 110. The server 190 may send the response packet corresponding to the client 110 via the routers 144 and 142 and the network 150. The server 190 may comprise, for example, a web server, a transaction server, a database server, and such other servers.

The network 150 may comprise one or more network devices such as a switch or a router, which may receive the packets, process the packets, and send the packets to an appropriate network device. The network 150 may enable transfer of packets between the client 110 and the server 190. The network devices of the network 150 may be configured to support various protocols such as TCP/IP.

The routers 142 and 144 may enable transfer of packets between the client 110 and the server 190 via the network 150. For example, the router 142 after receiving a packet, from the client 110, may determine the next router provisioned in the path and may forward the packet to the next router in the path. Also, a packet received from the network 150 may be forwarded to the client 110. The router 142 may determine the next router based on the entries in the routing table. The entries may comprise one or more address prefixes and corresponding port identifiers.

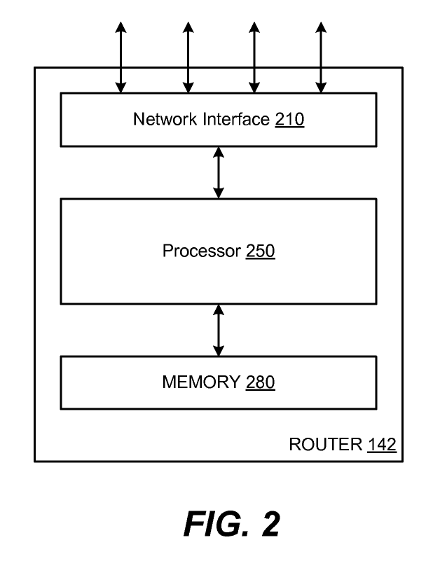

An embodiment of the router 142 is illustrated in FIG. 2. The router 142 may comprise a network interface 210, a processor 250, and a memory 280. The router 142 may receive one or more packets from the client 110 and may determine, for example, the output ports on which the packets may be forwarded to the adjacent network devices. However, similar embodiments may be implemented in the router 144 or other network devices.

The network interface 210 may transfer one or more packets between the client 110 and the network 150. For example, the network interface 210 may receive the packets from the client 110 and send the packet to the processor 250 for further processing. The network interface 210 may provide physical, electrical, and protocol interfaces to transfer packets between the client 110 and the network 150.

The memory 280 may store one or more packets and packet related information, such as packet descriptors, that may be used by the processor 250 to process the packets. In one embodiment, the memory 280 may store the packets, look-up tables, data structures that enable the processor 250 to process the packets. In one embodiment, the memory 280 may comprise a dynamic random access memory (DRAM) and a static random access memory (SRAM).

The processor 250 may receive one or more packets from the network interface 210, process the packets, and send the packets to the network interface 210. In one embodiment, the processor 250 may process the packets, for example, by performing header processing, packet validation, IP lookup, determining the output port and such other packet processing tasks before sending the packet to the network interface 210. In one embodiment, the processor 250 may comprise, for example, Intel® IXP2400 network processor.

In one embodiment, the processor 250 may comprise one or more microengines to perform packet processing. Each microengine may comprise one or more threads and a group of threads may be assigned to perform a logical function referred to as a microblock. In one embodiment, the processor 250 may maintain end-to-end packet ordering by decreasing the latency between the microblocks. In one embodiment, the processor 250 may utilize less memory to maintain the packet ordering.

In one embodiment, a next microblock may maintain the packet ordering based on whether a preceding microblock processed the packet successfully. In one embodiment, the next microblock reads, for example, the status of the packet processed by the preceding block before ordering the packets. In one embodiment, the preceding microblock may update the status corresponding to each packet after processing the packet.

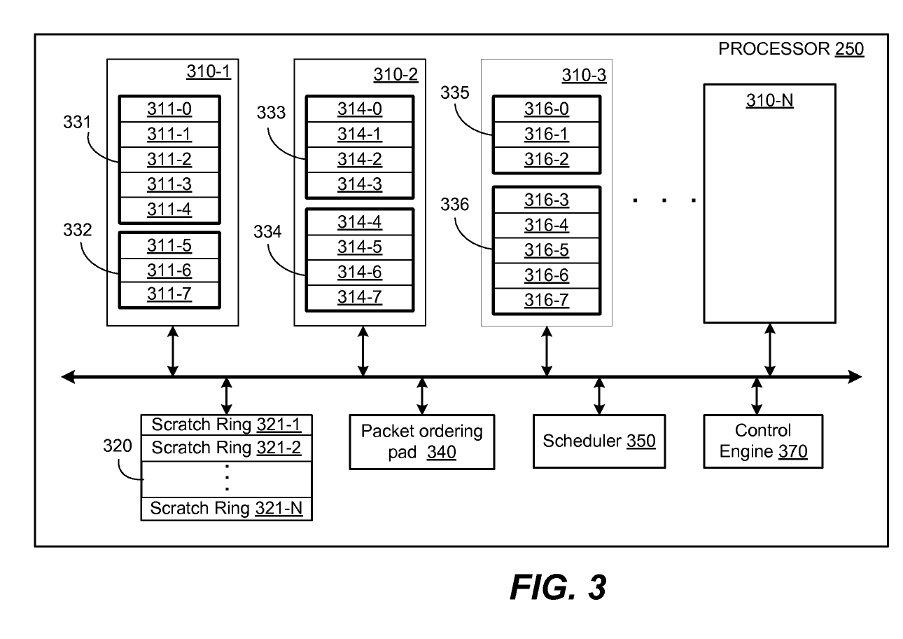

An embodiment of the processor 250 is illustrated in FIG. 3. The processor 250 may comprise one or more microengines 310-1 through 310-N, a scratch pad 320, a packet ordering pad 340, a scheduler 350, and a control engine 370.

The microengines 310-1 through 310-N may co-operatively operate to process the packets. Each microengine may process a portion of the packet processing task and may finally send the packet to the network interface 210. The processing of a packet may comprise sub-tasks such as reassembling of m-packets, packet validation, IP lookup, determining next hop IP address/MAC address and packet ordering to maintain end-to-end packet ordering.

In one embodiment, a sinking microengine ‘y’ may store information corresponding to a packet ‘x’ in a memory location Lxyz and a sourcing microengine ‘z’ may read the information from the memory location Lxyz to further process the packet ‘x’. For example, the microengine 310-1 may sink packet information corresponding to packet P0 into the memory location L012 and the microengine 310-2 may source or read the contents of the memory location Lxyz before processing P0 further.

In one embodiment, the microengines 310-1 through 310-N may support one or more microblocks. In one embodiment, the processor 250 may comprise eight microengines and each microengine in turn may comprise eight threads. A set of threads of each of the microengines 310-1 to 310-N may support a microblock. In one embodiment, the microengine 310-1 may support microblocks 331 and 332 respectively on the threads 311-0 to 311-4 and the threads 311-5 to 311-7. In one embodiment, the microblocks 331 and 332 may respectively represent a receive microblock and a packet processing microblock. In one embodiment, each thread 311-0 to 311-4 may perform a sub-task of the microblock 331.

The control engine 370 may support the microengines 310-1 through 310-N by updating the control tables such as the look-up tables. In one embodiment, the control engine 370 may comprise, for example, Intel® XScale™ core. The control engine 370 may create one or more microblocks that process network packets. The control engine 370 may allocate the threads of the microengines for executing the microblocks.

In one embodiment, the control engine 370 may receive input values from a user and may initialize the data structures based on the user inputs. In one embodiment, the data structures may receive and maintain configuration information such as the number of microblocks that may be initialized in the processor 250. The data structures may specify the cluster of the microengines that may execute the microblock. For example, the microengines 310-1 through 310-N of the processor 250 may be divided into two clusters cluster-1 and cluster-2.

The data structures may specify the start thread and the end thread that may execute a microblock, the microengine that supports the allocated threads, and the cluster that comprises the microengine. For example, the control engine 370 may specify that threads 311-0 to 311-4 of the microengine 310-1 of the cluster-1 may execute the microblock 331. The control engine 370 may allow the user to provide configuration data using interfaces such as an application programmable interface (API).

The scheduler 350 may schedule the microengines 310-1 through 310-N to perform a task corresponding to the assigned microblock. In one embodiment, the scheduler 350 may determine whether the microengine is free to execute the assigned microblock and data to execute the microblock is available. In one embodiment, the scheduler 350 may access the memory locations of the scratch pad 320 to determine if data to perform a corresponding task is available. The scheduler 350, before scheduling the microengine, may determine whether a pre-specified microengine assigned to execute the microblock is free by reading pre-specified data such as contents of a control status register.

In one embodiment, the scheduler 350 may be implemented as a piece of hardware. In other embodiments, the scheduler 350 may be implemented as a microblock supported on a group of threads. In another embodiment, the scheduler 350 may be implemented as a hardware piece in the control engine 370 and/or instructions executed by the control engine 370.

The scratch pad 320 may store, for example, a buffer handler and such other data exchanged between two microengines corresponding to each packet in a pre-specified memory location Lxyz. In one embodiment, the scratch pad 320 may comprise one or more scratch rings such as 321-1 to 321-N. In one embodiment, each of the scratch rings 321-1 to 321-N may comprise one or more memory locations such as Lxyz. In one embodiment, the microengine 310-1 and 310-2 may respectively use the scratch ring 321-1 to sink and source a corresponding buffer handler data. Further, the microengine 310-2 and 310-3 may respectively use the scratch ring 321-2 to sink and source a corresponding buffer handler data.

The packet ordering pad 340 may store, for example, one or more status flag variables and packet descriptors provided by a microblock. In one embodiment, the packet ordering pad 340 may be implemented using a first-in-first-out (FIFO) type memory. In one embodiment, the packet ordering block 340 may store a first status flag and the corresponding first packet descriptor in adjacent place holders or memory locations. The packet ordering pad 340 may store one or more such combinations of status flag variables and corresponding packet descriptors in adjacent place holders.

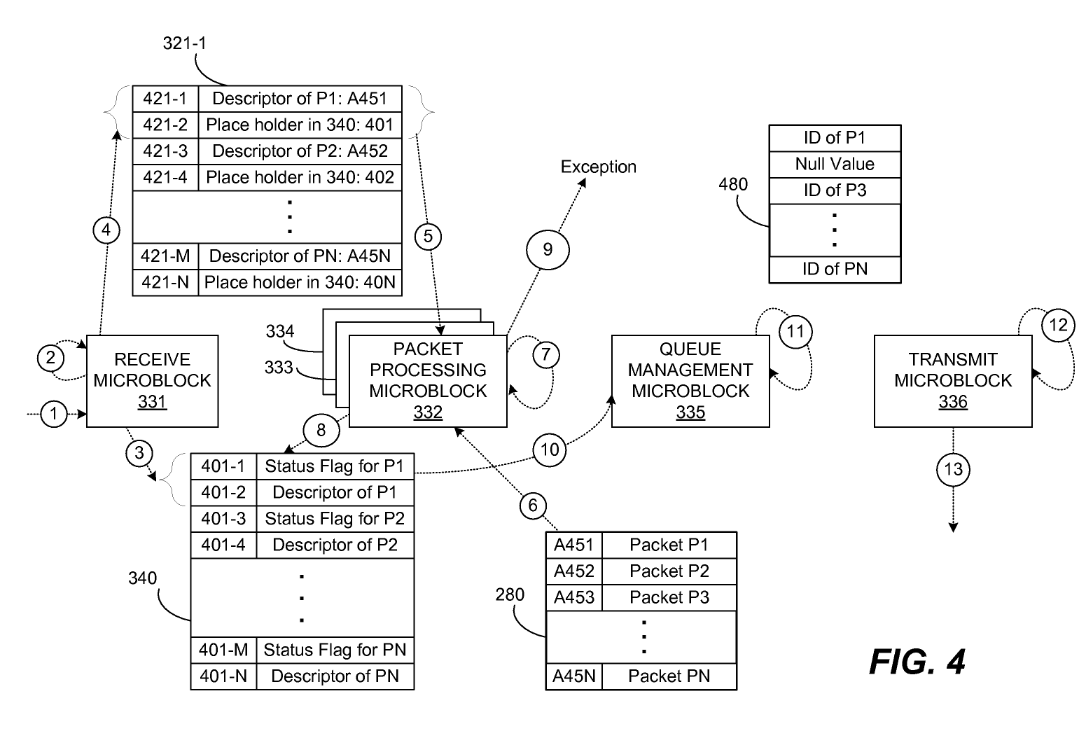

An embodiment of the processor 250 supporting various microblocks and to operate to maintain end-to-end packet ordering is illustrated in FIG. 4. In one embodiment, the microblocks 331, 332-334, 335, and 336 may represent a receive microblock, packet processing microblocks, a queue manager (QM) microblock, and a transmit microblock respectively.

In one embodiment, the receive microblock 331 may receive one or more cells such as m-data units or m-packets, as shown by flow pointer 1, from a interface device such as a network interface card (NIC) or a media switch fabric (MSF). The receive microblock 331 may process the m-data units to generate a corresponding packet. In one embodiment, the receive microblock 331 may operate based on an ordered thread model. In one embodiment, the receive microblock 331 may reassemble the m-data units, as shown by flow pointer 2, to construct a corresponding packet such as P1. The receive microblock 331 may store, as shown by flow pointer 3, a status flag (SF) and a descriptor of the packet P1 respectively in place holders 401-1 and 401-2 of the packet ordering pad 340.

In one embodiment, the receive microblock 331 may initialize the SF by storing a ‘0x0000’ in the place holder 401-1 and an address A451 of the memory location storing the packet P1, in the memory 280, in the place holder 401-2. The receive microblock 331 may then store, as shown by flow pointer 4, the descriptor of the packet P1, the address A451, and the address 401-1 of the place holder storing the status flag corresponding to the packet P1 in the scratch ring 321-1. The receive microblock 331 may then continue to process next set of m-data units.

In one embodiment, the scheduler 350 may initiate the packet processing microblock 332 to process the packets further. In one embodiment, the packet processing microblock 332 may access, as shown by flow pointer 5, the scratch ring 321-1 and retrieve the contents of the memory location 421-1 and 421-2. The packet processing microblock 332 may retrieve, as shown by flow pointer 6, the packet P1, from the memory location A451, based on the descriptor stored in the memory location 421-1. The packet processing microblock 332 may then process, as shown by the flow pointer 7, the packet P1. In one embodiment, the packet processing microblock may perform packet processing based on an unordered thread model. In one embodiment, the packet processing microblock 332 may perform operations such as IPV4/IPV6 forwarding, network address translation (NAT).

The packet processing microblock 332 may then set, as shown by flow pointer 8, the contents of the 401-1 (status flag of P1) to, for example, 0x1111 if the packet P1 is processed successfully and to 0xFFFF otherwise. In one embodiment, the packet processing microblock 332 may set the contents of 401-1 (status flag of P1) to 0xFFFF if the packet P1 is either dropped or sent to the control engine 370, as shown by flow pointer 9, by raising an exception. As a result, the packet processing microblock 332 may support unordered processing of packets.

Such an approach may reduce the programming complexity of the packet processing microblock 332 as the packet processing microblock 332 may not require data structures to track the flow of the packets in a strict-order. As a result such an approach may reduce various resource overheads such as processing overheads and memory overheads required to process the packets. In one embodiment, the packet processing microblock 332 may process the packet P1 while the receive microblock 331 may reassemble the m-packets corresponding to a packet P2. However, the packet processing microblock 332 may process the packets in an un-ordered sequence. In other words, the packet processing microblock 332 may not perform packet processing based on strict-ordering rules.

In one embodiment, the scheduler 350 may initiate the QM microblock 335 to process the packets further after the packet processing microblock 332 updates the status flag of P1. In one embodiment, the QM microblock 335 may comprise a queue to maintain the packet ordering such that the packets are sent onward in the same order as they were received. In one embodiment, the QM microblock 335 may retrieve, as shown by flow pointer 10, the content of the place holder 401-1, which represents the status flag of the packet P1. In one embodiment, the QM microblock 335 may retrieve the contents of the place holder 401-1 without waiting for a pre-determined amount of time. Such an approach may improve the efficiency of packet processing. For example, such an approach may enhance the speed of packet processing and may thus enable processing of packets at line speed.

In one embodiment, the QM microblock 335 may maintain ordering of packets based on processing, as shown by flow pointer 11, the status flag values stored in the place holders 401-1, 401-3, 401-5, and so on. In one embodiment, the QM microblock 335 may store the corresponding packet identifiers and null values respectively for packets processed successfully and unsuccessfully. In one embodiment, the QM microblock 335 may comprise a queue 480 comprising one or more locations to store packet identifiers in order.

In one embodiment, the QM microblock 335 may access the content of the place holder 401-1, determine that 401-1 comprises 0x1111, and store a packet identifier of P1 in a pre-specified memory location of the ordered queue 480. The QM microblock 335 may then retrieve the contents of the place holder 401-3 and determine, based on 0xFFFF stored in 401-3, that the packet P2 is either dropped or sent to the control engine 370. The QM microblock 335 may store a null value in a pre-specified location of the ordered queue 480.

In one embodiment, the QM microblock 335 may maintain pointers to read the contents of the packet ordering pad 340 and to store either the packet identifier or the null value in a corresponding location of the ordered queue 480. The QM microblock 335 may thus maintain the ordering of one or more packets processed successfully by the packet processing microblock 332. The transmit microblock 336, as shown by flow pointer 12, processes the packets in the order indicated by the QM microblock 335. The transmit microblock 336 may then transmit the packets as indicated by flow pointer 13.

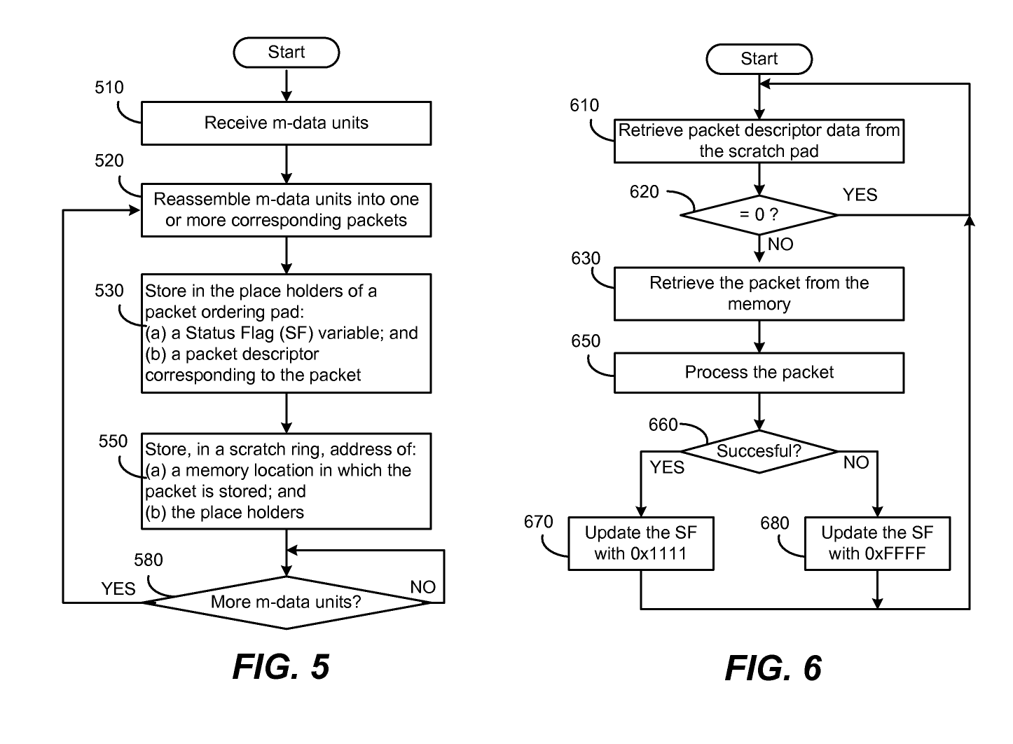

An embodiment of an operation of the receive microblock 331 is illustrated in FIG. 5. In block 510, the receive microblock 331 may receive one or more m-data units or cells. In block 520, the receive microblock 331 may reassemble m-data units into one or more corresponding packets.

In block 530, the receive microblock 331 may store (a) a status flag (SF) variable equaling 0x0000 and (b) a packet descriptor (e.g., A451) in which the packet P1 is stored in the memory 280 respectively in the place holders 401-1 and 401-2, of the packet ordering pad 340.

In block 550, the receive microblock 331 may store address of: (a) a memory location (A451) in which the packet P1 is stored and (b) the place holder (401-1) storing a corresponding SF variable respectively in the memory locations 421-1 and 421-2 of the scratch ring 321-1.

In block 580, the receive microblock 331 may check for presence of more m-data units and control passes to block 520 if more m-data units are present and may wait in a loop to receive more m-data units.

An embodiment of an operation of the packet processing microblock 332 is illustrated in FIG. 6. In block 610, the packet processing microblock 332 may retrieve a packet descriptor (A451) from the memory location 421-1 of the scratch pad 321-1. In block 620, the packet processing microblock 332 may check whether the retrieved data equals ‘0’ and control passes to block 630 if the content is not equal to ‘0’ and to block 610 otherwise.

In block 630, the packet processing microblock 332 may retrieve the packet P1 from the memory 280. In block 650, the packet processing microblock 332 may process the packet P1. In one embodiment, the packet processing microblock 332 may determine the next hop router by performing a IP look-up.

In block 660, the packet processing microblock 332 may check if the processing was successful and control passes to block 670 if the packet processing is successful and to block 680 otherwise.

In block 670, the packet processing microblock 332 may update the SF, for example, with 0x1111. In block 680, the packet processing microblock 332 may update the SF, for example, with 0xFFFF and control may pass to block 610 to process the next packet.

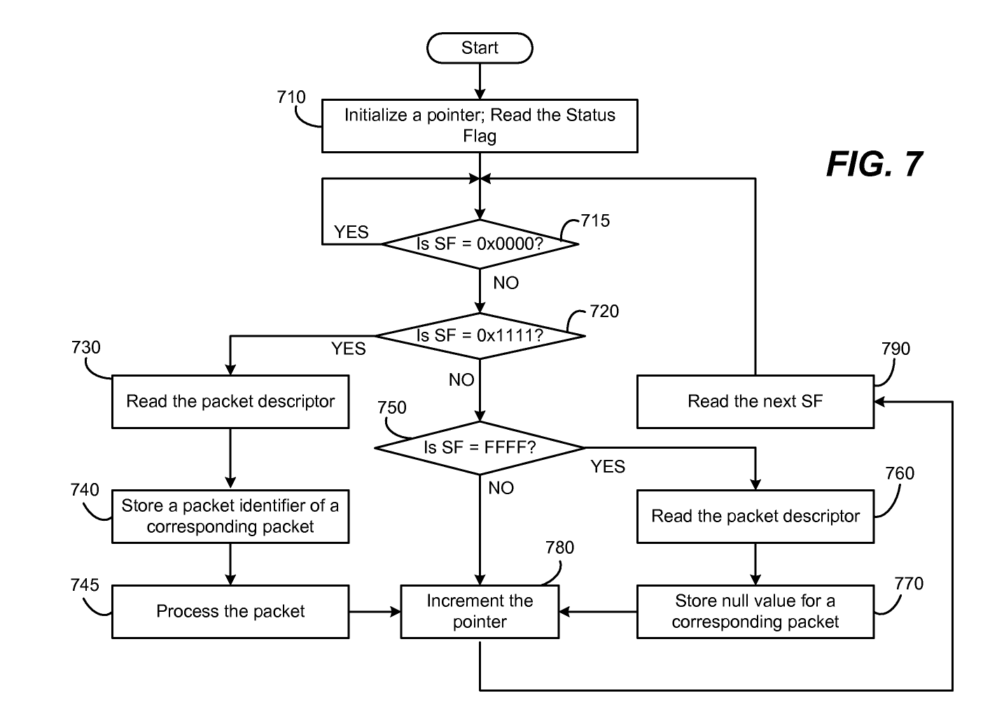

An embodiment of an operation of the queue manager (QM) microblock 335 is illustrated in FIG. 7. In block 710, the QM microblock 335 may initialize a pointer to point to a first location (401-1) in the packet ordering pad 320 and the QM microblock 335 may read the contents of the SF corresponding to the packet P1.

In block 715, the QM microblock 335 may check whether the content of the SF at location 401-1 equals 0x0000 and control passes to block 720 if the condition is not true and to block 715 otherwise. In block 720, the QM microblock 335 may check whether the content of the SF at location 401-1 equals 0x1111 and control passes to block 730 if the condition is true and to block 750 otherwise.

In block 730, the QM microblock 335 may read the packet descriptor (A451) that correspond to the packet P1 from the place holder 401-2. In block 740, the QM microblock 335 may store an identifier of the packet P1 in a pre-specified memory location of an ordered queue 480.

In block 745, the QM microblock 335 may process the packets. For example, the QM microblock 335 may send the packets to a specified queue and may then send an indication to the scheduler 350. In block 750, the QM microblock 335 may check whether the content of the SF at location 401-1 equals 0xFFFF and control passes to block 760 if the condition is true and to block 780 otherwise.

In block 760, the QM microblock 335 may read the packet descriptor (A451). In block 770, the QM microblock 335 may store a null value in a pre-specified memory location of the ordered queue 480.

In block 780, the QM microblock 335 may increment the pointer to point to next SF (401-3). In block 790, the QM microblock 335 reads the next SF, for example, stored at a place holder 401-3 and control passes to block 715.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. An apparatus comprising
a first set of threads to process a plurality of packets received in a first order and to store a descriptor of each packet of the plurality of packets in a packet ordering pad,
a second set of threads to process each packet of the plurality of packets in a second order and to store a status value for each packet of the plurality of packets in a corresponding status flag of a plurality of status flags maintained in the packet ordering pad, and
a third set of threads to maintain an end-to-end packet ordering by restoring the first order based on the status value of each packet of the plurality of packets stored in the corresponding status flag of the plurality of status flags.

2. The apparatus of claim 1 further comprises a scratch ring to store the descriptor of each packet of the plurality of packets and a pointer to each of the corresponding status flag of the plurality of status flags stored in the packet ordering pad, wherein the first set of threads store the descriptor of each packet of the plurality of packets and the pointer to each of the corresponding status flag of the plurality of the status flags.

3. The apparatus of claim 2 wherein the second set of threads
identify each packet of the plurality of packets to process based on the descriptor of each packet of the plurality of packets stored in the scratch ring,
identify the corresponding status flag of the plurality of status flags of each packet of the plurality of packets based on the pointer to each of the corresponding status flag of the plurality of status flags, and
store a first value in the corresponding status flag of the plurality of status flags for a packet of the plurality of packets if the packet is successfully processed and store a second value otherwise.

4. The apparatus of claim 1 wherein the third set of threads
retrieve the corresponding status value of the plurality of status flags stored for each packet of the plurality of packets based on the descriptor of each packet of the plurality of packets stored in the packet ordering pad,
store a packet identifier of each packet of the plurality of packets that is successfully processed in a corresponding location in a queue and store a default value otherwise, wherein the queue maintains the first order, and
send each packet of the plurality of packets onward in the first order.

5. The apparatus of claim 1 wherein the packet ordering pad comprises a first-in-first-out memory to store the plurality of status flags and the descriptor of each packet of the plurality of packets in adjacent memory locations of the first-in-first-out memory.

6. The apparatus of claim 1 further comprises a control engine to receive one or more packets of the plurality of packets that the second set of threads process unsuccessfully.

7. The apparatus of claim 1 further comprises a scheduler to schedule the second set of threads based on one or more data values generated by the first set of threads and to schedule the third set of threads based on one or more data values generated by the second set of threads.

8. The apparatus of claim 1 wherein the first set of threads support a receive microblock.

9. The apparatus of claim 1 wherein the second set of threads support a packet processing microblock.

10. The apparatus of claim 1 wherein the third set of threads support a queue manager microblock.

11. A method comprising
storing a descriptor of each packet of the plurality of packets in a first memory in response to a first microblock processing each packet of the plurality of packets received in a first order,
storing a status value for each packet of the plurality of packets in a corresponding status flag of a plurality of status flags maintained in the first memory in response to a second microblock processing each packet of the plurality of packets in a second order, and
maintaining an end-to-end packet ordering in response to a third block restoring the first order based on the status value of each packet of the plurality of packets stored in the corresponding status flag of the plurality of status flags.

12. The method of claim 11 further comprises storing, in a second memory, the descriptor of each packet of the plurality of packets and a pointer to each of the status flag of the plurality of status flags stored in the first memory.

13. The method of claim 12 further comprises
identifying each packet of the plurality of packets based on the descriptor of each of the plurality of packets stored in the second memory,
identifying the corresponding status flag of the plurality of status flags of each packet of the plurality of packets based on the pointer to each of the status flag of the plurality of status flags, and
storing a first value in the corresponding status flag of the plurality of status flags for a packet of the plurality of packets if the packet is successfully processed and store a second value otherwise.

14. The method of claim 11 further comprises
retrieving the corresponding status value of the plurality of status flags stored for each packet of the plurality of packets based on the descriptor of each packet of the plurality of packets stored in the packet ordering pad,
storing, in a corresponding location in a queue, a packet identifier of each packet of the plurality of packets that is successfully processed and storing a default value otherwise, wherein storing in the queue maintains the first order, and
sending each packet of the plurality of packets onward in the first order.

15. The method of claim 11 wherein the corresponding status flag of the plurality of status flags and the descriptor of each packet of the plurality of packets is stored in the first memory based on a first-in-first-out policy.

16. The method of claim 11 further comprises generating an exception corresponding to one or more packets of the plurality of packets that is processed unsuccessfully.

17. The method of claim 11 further comprises
scheduling the second microblock based on one or more data values generated by the first microblock, and
scheduling the third microblock based on one or more data values generated by the second microblock.

18. A machine-readable medium comprising a plurality of instructions that in response to being executed result in a processor
storing a descriptor of each packet of the plurality of packets in a first memory in response to a first microblock processing each packet of the plurality of packets received in a first order,
storing a status value for each packet of the plurality of packets in a corresponding status flag of a plurality of status flags maintained in the first memory in response to a second microblock processing each packet of the plurality of packets in a second order, and
maintaining an end-to-end packet ordering in response to a third block restoring the first order based on the status value of each packet of the plurality of packets stored in the corresponding status flag of the plurality of status flags.

19. The machine-readable medium of claim 18 further comprises storing, in a second memory, the descriptor of each packet of the plurality of packets and a pointer to each of the status flag of the plurality of status flags stored in the first memory.

20. The machine-readable medium claim 19 further comprises
identifying each packet of the plurality of packets based on the descriptor of each of the plurality of packets stored in the second memory,
identifying the corresponding status flag of the plurality of status flags of each packet of the plurality of packets based on the pointer to each of the status flag of the plurality of status flags, and
storing a first value in the corresponding status flag of the plurality of status flags for a packet of the plurality of packets if the packet is successfully processed and store a second value otherwise.

21. The machine-readable medium of claim 18 further comprises
retrieving the corresponding status value of the plurality of status flags stored for each packet of the plurality of packets based on the descriptor of each packet of the plurality of packets stored in the packet ordering pad,
storing, in a corresponding location in a queue, a packet identifier of each packet of the plurality of packets that is successfully processed and storing a default value otherwise, wherein storing in the queue maintains the first order, and
sending each packet of the plurality of packets onward in the first order.

22. The machine-readable medium of claim 18 wherein the corresponding status flag of the plurality of status flags and the descriptor of each packet of the plurality of packets is stored in the first memory based on a first-in-first-out policy.

23. The machine-readable medium of claim 18 further comprises generating an exception corresponding to one or more packets of the plurality of packets that is processed unsuccessfully.

24. The machine-readable medium of claim 18 further comprises scheduling the second microblock based on one or more data values generated by the first microblock, and
scheduling the third microblock based on one or more data values generated by the second microblock.

25. A network device comprising
a network interface to transfer packets,
a memory to store packet data, and
a processor comprising a first microblock to process a plurality of packets received in a first order and to store a descriptor of each packet of the plurality of packets in a packet ordering pad, a second microblock to process each packet of the plurality of packets in a second order and to store a status value for each packet of the plurality of packets in a corresponding status flag of a plurality of status flags maintained in the packet ordering pad, and a third microblock to maintain an end-to-end packet ordering by restoring the first order based on the status value of each packet of the plurality of packets stored in the corresponding status flag of the plurality of status flags.

26. The network device of claim 25 wherein the processor receives and sends the plurality of packets in a first order and processes the plurality of packets in a second order, wherein the first order is not equal to the second order.

27. The network device of claim 25 wherein the processor comprises a plurality of threads to support the first, second, and the third microblock.

28. The network device of claim 25 wherein the processor schedules the second microblock after the first microblock sinks data and schedules the third microblock after the second microblock sinks data.
